(19) United States
(12) Patent Application Publication
(10) Pub. No.: US 2010/0316336 A1
(43) Pub. Date: Dec. 16, 2010

(54) Optical module having an engaging protrusion

(75) Inventors: Akihito Kezuka, Kawasaki (JP); Tsutomu Ohtsu, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU OPTICAL COMPONENTS LIMITED, Kawasaki (JP)

(21) Appl. No.: 12/662,943

(22) Filed: May 12, 2010

(30) Foreign Application Priority Data
Jun. 15, 2009 (JP) 2009-142506

(51) Int. Cl. G02B 6/36

(52) U.S. Cl. 385/92

(57) ABSTRACT

An optical module is accommodated in a cage. The optical module includes a case that accommodates optical parts. A projection having a vertical surface perpendicular to a longitudinal direction of the case is provided on a surface of the case. A slide member includes a base part, an inclined part and a slide tab. The base part is attached on one end of the case and movable in the longitudinal direction of the case. The inclined part extends in an oblique direction from the base part. The slide tab extends in the longitudinal direction beyond the projection and is movable in the longitudinal direction within a predetermined moving range. A protruding part protruding from the surface of the case is provided on a side of the base part of the slide member with respect to the projection.

### CROSS-REFERENCE TO RELATED APPLICATIONS

This application is based upon and claims the benefit of priority of the prior Japanese Patent Application No. 2009-142506, filed on Jun. 15, 2009, the entire contents of which are incorporated herein by reference.

### FIELD

The embodiment discussed herein is directed to an optical module configured to be accommodated in a cage.

### BACKGROUND

An optical module, which is an optical transceiver unit, is incorporated into an optical communication apparatus used for optical communications. In order to incorporate an optical module into the optical transmission apparatus as an optical communication apparatus, a cage for accommodating the optical module is used. That is, a cage for accommodating an optical module is attached inside the optical communication apparatus so that the optical module can be incorporated into the optical communication apparatus by inserting and accommodating the optical module in the cage attached inside the optical communication apparatus.

The optical module can be detachably attached to the cage, and the optical module can be taken out of the optical communication apparatus, if necessary, by pulling the optical module out of the cage. Therefore, the optical module and the cage are provided with a locking mechanism for fixing the optical module in a state accommodated inside the cage.

A locking mechanism generally used as a locking mechanism for optical modules includes a projection provided to a case of an optical module and a tongue-like tab provided to a cage (for example, refer to U.S. Pat. No. 7,347,711). The optical module is locked to the cage by the projection of the optical module being engaged with an aperture part provided in the tongue-like tab of the cage. Unlocking of the optical module can be performed by disengaging the aperture part from the projection by lifting the tongue-like tab by tilting a lever member referred to as a bail provided to the optical module.

First, a description will be given, with reference to FIGS. 1A and 1B, of an optical module and a cage. An optical module 10 generally includes optical parts accommodated in an elongated case 12. An optical connector 14 for connecting the optical parts is provided at one end of the case 12. A bail 16 is rotatably attached to the end part of the case 12 to which the optical connector 14 is provided.

A cage 20 is a metal made cover having a box-like shape of which one end is open. The cage 20 is configured to receive the case 12, which is inserted into the cage 20 from an opposite side of the end part to which the optical connector 14 is provided, as illustrated in FIG. 1A. The cage 20 is incorporated into an optical communication apparatus after being attached to a board, or the cage 20 is directly attached to a frame or the like of the optical communication apparatus. A state where the optical module 10 is completely accommodated in the cage 20 is illustrated in FIG. 1B.

FIG. 2 is a perspective view of the optical module 10 viewed from a bottom side. In the case 12 of the optical module 10, a slide member 18 is attached to a bottom side of a portion to which a bail 16, which serves as a lever member, is attached. The slide member 18 is movable in a longitudinal direction of the case 12 in association with a rotation of the bail 16. In a state where the bail 16 is raised or upright (a state illustrated in FIG. 2), the slide member 18 is shifted to the right in FIG. 2. When the bail 16 is brought down from the upright position, the slide member 18 moves in a leftward direction in FIG. 2. The motion of the slide member 18 will be explained later.

FIG. 3 is an enlarged view of an encircled part A of FIG. 2. A concave portion 12a is formed in a bottom surface of the case 12 of the optical module 10. A projection 13 is formed in a bottom surface of the concave portion 12a. A slide tab 18a, which is a part of the slide member 18, is inserted into the concave portion 12a so that the projection 13 enters an aperture 18b formed in the slide member 18 and protrudes to the opposite side. A slide part 18c is formed on an edge of the aperture 18b of the slide tab 18a. The slide part 18c is formed by bending a metal plate into a U-shape so that a rounded portion formed by bending is slidable on a sloped surface 13b of the projection 13 as mentioned later. The projection 13 is formed of a metal and has a vertical surface 13a and the sloped surface 13b. The vertical surface 13a of the projection 13 is provided to lock the optical module 10 to the cage 20 by engaging with a tongue-like tab 20a of the cage 20 as explained later.

FIG. 4 is a perspective view of the cage 20 viewed from a bottom side. FIG. 5 is an enlarged view of an encircled part B of FIG. 4. The cage 20 is formed of a thin metal plate such as, for example, a stainless steel plate. The tongue-like tab 20a is formed in a portion on the bottom surface side where the projection 13 of the optical module 10 is positioned when the optical module 10 is inserted into the cage 20. The tongue-like tab 20a is formed by cutting a portion of the cage 20 in an elongated shape. A tongue-like tab hole 22 is formed in the tongue-like tab 20a. The tongue-like tab hole 22 has a size so that a portion of the projection 13 can be inserted into. The vertical surface 13a of the projection 13 is brought into contact with a front edge 22a of the tongue-like tab hole 22 when the projection 13 enters the tongue-like tab hole 22 so that the optical module 10 is locked to the cage 20.

A locking mechanism for fixing the optical module 10 to the cage 20 is achieved by the projection 13, the slide member 18 and the bail 16 associated with the slide member 18 of the optical module 10 and the tongue-like tab 20a of the cage 20.

A description will be given below of the locking mechanism.

FIG. 6 is a perspective view of the cage 20 in which the optical module 10 is accommodated. FIG. 7 is an enlarged view of an encircled portion A of FIG. 6. In order to insert the optical module 10 into the cage 20, the bail 16 is set in an upright position. When the bail 16 is in the upright position, the slide member 18, which is interlocked with the bail 16, is moved to the right-side position in FIG. 6. Thereby, the slide tab 18a of the slide member 18 is also moved to the right-side position. Thus, the projection 13 entirely enters the aperture 18b of the slide tab 18a, and the projection 13 protrudes the underside of the slide tab 18a by passing through the aperture 18b of the slide tab 18a. When the optical module 10 is inserted into the cage 20 in this state, the projection 13 of the optical module 10 is brought into contact with an end of the tongue-like tab 20a of the cage 20. Then, when the optical module 10 is inserted further into the cage 20, the tongue-like tab 20a of the cage 20 runs onto the sloped surface 13b of the projection 13. By further inserting the optical module 10 into the cage 20, the optical module 10 is completely accommodated in the cage 20, and a portion of the projection 13 is aligned with the tongue-like tab hole 22 of the tongue-like tab 20a. Because a press-down force is generated in the tongue-like tab 20a due to its elastic force, a portion of the projection 13 enters the tongue-like tab hole 22 of the tongue-like tab 20a and the vertical surface 13a of the projection 13 is brought into contact with the front edge 22a of the tongue-like tab hole 22. Thereby, the projection is prevented from moving in an opposite direction to the inserting direction, and the optical module 10 is locked in the state where the optical module 10 is accommodated in the cage 20.

In order to pull the optical module 10 out of the cage 20, it is necessary to unlock the optical module 10. When unlocking the optical module 10, the bail 16 of the optical module 10 is brought down to rotate by 90 degrees. FIG. 8 is a perspective view of the optical module accommodated in the cage 20 in a state where the bail 16 is brought down. FIG. 9 is an enlarged view of an encircled part B of FIG. 8. When the bail 16 is brought down, the slide member 18 moves in a leftward direction in FIG. 8, and the slide tab 18 of the slide member 18 also moves in the leftward direction. At this time, the slide part 18c formed on the edge of the aperture 18b of the slide tab 18a slides on the sloped surface 13b of the projection 13, thereby lifting the slide tab 18a along the sloped surface 13b.

FIG. 9 illustrates a state where the slide part 18c moves to a flat surface above the sloped surface 13b. The tongue-like tab 20a positioned under the slide tab 18b is lifted by the slide tab 18b being lifted as in the state illustrated in FIG. 9, and the tongue-like tab hole 22 (hereinafter, may be referred to as an aperture 22) of the tongue-like tab 20a moves to a position higher than the projection 13 and is disengaged from the projection 13. Therefore, the engagement of the front edge 22a of the aperture 22 of the tongue-like tab 20a and the vertical surface 13a of the projection 13 is canceled, and the projection 13 can move in the leftward direction in FIG. 9. That is, the lock of the optical module 10, which is provided with the projection 13, to the cage 20 is canceled, and the optical module 10 can be pulled out of the cage 20.

FIG. 10 is a schematic side view illustrating the positional relationship between the bail 16, the slide member 18 and the projection 13, which are in a locked state. FIG. 11 is an enlarged view of an encircled portion C of FIG. 10. In the locked state, the bail 16 is at the upright position, and the slide member 18 is shifted to the right side in FIG. 10. Accordingly, the slide tab 18a, which is a part of the slide member 18, is shifted to the right side, and the projection 13 passes through the aperture 18b of the slide tab 18a and protrudes from the aperture 18b. The tongue-like tab 20a of the cage 20 engages with the projection 13 protruding from the slide tab 18a, which achieves the locked state. In the locked state, the slide part 18c of the slide tab 18a is at a position lower than the sloped surface 13b of the projection 13.

FIG. 12 is a schematic side view illustrating the positional relationship between the bail 16, the slide member 18 and the projection 13, which are in an unlocked state. FIG. 13 is an enlarged view of an encircled portion D of FIG. 12. In the unlocked state, the bail 16 is brought down, and the slide member 18 is shifted to the left side in FIG. 12. Accordingly, the slide tab 18a, which is a part of the slide member 18, is shifted to the left side, and the slide part 18c of the slide tab 18a is moved to the flat surface above the sloped surface 13b of the projection 13 after sliding on the sloped surface 13b. Accordingly, the slide tab 18 is lifted along the sloped surface 13b, and the tongue-like tab 20a of the cage 20 positioned under the slide tab 18a is lifted by the slide tab 18a. Thus, the unlocking is performed by the lifting action of the slide tab 18a.

A description will be given below, with reference to FIG. 14 and FIG. 15, of motion of the slide tab 18a and the tongue-like tab 20a during an unlocking operation. FIG. 14 is a schematic side view illustrating a positional relationship between the slide tab 18a, the tongue-like tab 20a and the projection 13, which are in the locked state. FIG. 15 is a schematic side view illustrating a positional relationship between the slide tab 18a, the tongue-like tab 20a and the projection 13, which are in the unlocked state.

In the locked state, the bail 16 is raised, and the slide member 18 is shifted to the right side in FIG. 10. Accordingly, the slide tab 18a, which is a part of the slide member 18, is moved to the right side and the projection 13 passes through the aperture 18b and protrudes from the aperture 22. The slide part 18c provided at the end part of the slide tab 18a is not in contact with the sloped surface 13b of the projection 13. Then, the projection protruding form the slide tab 18a protrudes into the aperture 22 of the tongue-like tab 20a of the cage 20. Thereby, the front edge 22a of the aperture 22 of the tongue-like tab 20a is brought into contact with the vertical surface 13a of the projection 13, which achieves the locked state.

When the bail 16 is brought down from the locked state, the slide member 18 moves in the leftward direction by being interlocked with the rotation of the bail 16. When the slide member 18 moves in the leftward direction, the slide part 18c of the slide member 18 first contacts the sloped surface 13b of the projection 13. When the bail 16 is brought down further, the slide part 18a moves in the leftward direction while the slide part 18c slides on the sloped surface 13b of the projection 13 in a direction indicated by an arrow in FIG. 15. At this time, the slide tab 18a moves in the leftward direction while the slide tab 18a slightly inclines so that the slide part 18c is positioned on the under side because the slide part 18c is lifted by the sloped surface 13b. Additionally, the tongue-like tab 20a is lifted by the slide part 18 near the slide part 18c because the slide part 18c is lifted by the sloped surface 13b.

When the bail 16 is rotated by 90 degrees and completely brought down, as illustrate in FIG. 15, the lifting height of the slide part 18c is sufficient, and the aperture 22 of the tongue-like tab 20a is set in a state where the aperture 22 is disengaged from the projection 13. Thus, the unlocked state is set, and the optical module 10 can be pulled out of the cage 20 by pulling the bail 16 in the longitudinal direction of the optical module 10.

In the above-mentioned operation of the slide tab 18a, when shifting from the locked state illustrated in FIG. 14 to the unlocked state illustrated in FIG. 15, the slide tab 18a moves while the slide tab 18a inclines so that the side of the slide part 18c is positioned on the underside. Thereby, a force to pull the slide tab 18a in the direction of inclination is exerted on a portion of the slide part 18c of the slide tab 18, which is in contact with the sloped surface 13b. Thus, the slide part 18c slides on the sloped surface 13b due to a component force of the pulling force of the slide tab 18a in the direction of inclination of the sloped surface 13b. Here, a component force of the pulling force of the slide tab 18a in a direction perpendicular to the direction of inclination of the sloped surface 13b corresponds to a pressing force to press the slide part 18c against the sloped surface 13b.

In the above-mentioned unlocking operation, the slide member 18, which is coupled to the bail 16, is pulled by the bail 16 being brought down, and the edge of the slide tab 18a slides on the sloped surface 13b of the projection 13 and the slide tab 18a is lifted. At this time, the tongue-like tab 20a of the cage 20, which is engaged with the projection 13 above the slide tab 18a, is lifted by the slide tab 18a, which results in disengagement between the aperture 22 of the tongue-like tab 20a and the projection 13.

When the edge of the slide tab 18a slides on the sloped surface 13b of the projection 13, a force to press the slide tab 18a against the sloped surface 13b is exerted on the edge of the slide tab 18a. The projection 13 provided to the cage 12 of the optical module 10 is formed of a metal such as a die-cast aluminum or the like. On the other hand, the slide member 18, which slides on the sloped surface 13b of the projection 13, is formed of a metal plate. When attachment and detachment of the optical module 10 are repeated, a recess may be formed on the sloped surface 13b of the projection 13 in a portion where the edge of the slide tab 18a is strongly pressed against the sloped surface 13a of the projection 13.

If a recess is formed on the sloped surface 13b of the projection 13, the slide tab 18a may be caught by the recess, which prevents the slide tab 18a from being pulled by a small force. That is, a large force must be applied to the slide member 18 by bringing the bail 16 down with a large force. If attachment and detachment of the optical module 10 are repeated after the recess is formed on the sloped surface 13b of the projection 13, the recess becomes deep, and, finally, the edge of the slide tab 18a is strongly caught by the deep recess. In such a case, the slide member 18 cannot be moved even if an extremely large force is applied to the bail 16. That is, the bail 16 cannot be brought down completely, and the edge of the slide tab 18a stays in engagement with the projection 13. Thus, unlocking cannot be performed, which results in a state where the optical module 10 cannot be pulled out of the cage 20.

FIG. 16 is an illustration illustrating positions of the slide tab 18a, from a position of start of movement to a position where the slide part 18c of the slide tab 18a contacts the sloped surface 13b of the projection 13 and further to a position where the slide part 18c slides along the sloped surface 13b. In FIG. 16, the slide tab 18a, which is in a state where the slide part 18c of the slide tab 18a starts to move and contacts the sloped surface 13b, is illustrated by dashed lines, and the slide tab 18a, which is in a state where the slide part 18c is sliding on the sloped surface 13b, is illustrated by solid lines. It is appreciated from FIG. 16 that the inclination angle of the slide tab 18a increases as the slide tab 18 moves.

FIG. 17 is an illustration illustrating a force applied to the sloped surface 13b by the slide part 18c at a start of movement of the slide member 18. At the time of start of movement of the slide member 18, the slide tab 18a is in a horizontal position and a pulling force F0 to pull the slide tab 18a is in a horizontal direction. A pressing force F1 applied to the sloped surface 13b by the slide part 18c in a direction perpendicular to the sloped surface 13b is a component force of the pulling force F0. The pressing force F1 is represented by F0 multiplied by sine (F1=F0×sin θ), where θ is an inclination angle of the sloped surface 13b relative to the horizontal direction.

FIG. 18 is an illustration illustrating a force applied by the slide part 18c onto the sloped surface 13b while the slide part 18c of the slide tab 18a is sliding on the sloped surface 13b. When the slide part 18c moves along the sloped surface 13b while sliding on the sloped surface 13b, the slide tab 18a inclines relative to the horizontal direction, and an angle (inclination angle) θ of the slide tab 18a increases gradually. Under such a condition, a pressing force F2 applied by the slide part 18c onto the sloped surface 13b in a direction perpendicular to the sloped surface 13b corresponds to a component force of the pulling force F0. The pressing force F1 is represented by the F0 multiplied by sin(θ+θ1) (F1=F0×sin(θ+θ1), where θ is the inclination angle of the sloped surface 13c relative to the horizontal direction. Accordingly, the pressing force F2 by which the slide part 18c is pressed against the sloped surface 13b increases as the slide part 18c slides on the sloped surface 13b (F1<F2).

As mentioned above, if the component force F2 corresponding to the pressing force to press the sloped surface 13b becomes large, as illustrated in FIG. 19, a recess is formed on the sloped surface 13b of the projection 13, which is formed by a relatively soft material such as an aluminum die-cast, due to the slide part 18c being pressed against the sloped surface 13b. Once such a recess is formed, the pulling force F applied to the slide tab 18a is increased. Thus, the pressing force F2 applied by the slide part 18c becomes larger, which results in an increase in the depth of the recess. If the depth of the recess reaches a certain level, the slide part 18c cannot move out of the recess, and, thereby the slide tab 18a cannot be moved any more. In such a state, the bail 16 cannot be brought down completely and unlocking cannot be achieved. Accordingly, the optical module 10 cannot be pulled out of the cage 20.

Thus, it is desirable to prevent the slide part 18c from being pressed against the sloped surface 13b or, if the slide part 18c is pressed against the sloped-surface, reduce the pressing force so that a recess is not formed on the sloped surface 13b. By doing this, the slide tab 18a is prevented from being set in a condition where the slide tab 18a cannot be moved by a pulling force, which permits the optical module 10 to be attached to and detached from the cage 20 for more times.

### SUMMARY

According to an embodiment, an optical module configured to be accommodated in a cage includes: a case accommodating optical parts; a projection provided on a surface of the case and having a vertical surface perpendicular to a longitudinal direction of the case; a slide member including a base part, an inclined part and a slide tab, the base part being attached on one end of the case and movable in the longitudinal direction of the case, the inclined part extending in an oblique direction from the base part, the slide tab extending in the longitudinal direction beyond the projection and being movable in the longitudinal direction within a predetermined moving range; and a protruding part provided on a side of the base part of said slide member with respect to the projection and protruding from the surface of the case.

The object and advantages of the embodiment will be realized and attained by means of the elements and combinations particularly pointed out in the appended claims.

It is to be understood that both the foregoing general description and the following detailed description are exemplary explanatory only and are not restrictive of the invention, as claimed.

### BRIEF DESCRIPTION OF DRAWINGS

FIG. 1A is a perspective view of an optical module and a cage in a state where the optical module is taken out of the cage;

FIG. 1B is a perspective view of the optical module and the cage in a state where the optical module is inserted into the cage;

FIG. 2 is a perspective view of the optical module viewed from a bottom side;

FIG. 3 is an enlarged view of an encircled part A of FIG. 2;

FIG. 4 is a perspective view of a cage viewed from a bottom side;

FIG. 5 is an enlarged view of an encircled part B of FIG. 4;

FIG. 6 is a perspective view of the cage in which the optical module is accommodated;

FIG. 7 is an enlarged view of an encircled portion A of FIG. 6;

FIG. 8 is a perspective view of the optical module accommodated in the cage in a state where a bail is brought down;

FIG. 9 is an enlarged view of an encircled part B of FIG. 8;

FIG. 10 is a schematic side view illustrating a positional relationship between the bail, a slide member and a projection, which are in a locked state;

FIG. 11 is an enlarged view of an encircled portion C of FIG. 10;

FIG. 12 is a schematic side view illustrating a positional relationship between the bail, the slide member and the projection, which are in an unlocked state;

FIG. 13 is an enlarged view of an encircled portion D of FIG. 12;

FIG. 14 is a schematic side view illustrating a positional relationship between a slide tab, a tongue-like tab and the projection, which are in the locked state;

FIG. 15 is a schematic side view illustrating a positional relationship between the slide tab, the tongue-like tab and the projection, which are in the unlocked state;

FIG. 16 is an illustration illustrating positions of the slide tab 18a, from a position of start of movement to a position where a slide part slides along a sloped surface;

FIG. 17 is an illustration illustrating a force applied to the sloped surface by the slide part at a start of movement of the slide member;

FIG. 18 is an illustration illustrating a force applied by the slide part onto the sloped surface while the slide part is sliding on the sloped surface;

FIG. 19 is an illustration for explaining a recess formed on the sloped surface;

FIG. 20 is a schematic side view of a part of an optical module according to an embodiment;

FIG. 21 is an illustration for explaining a pressing force applied by a slide tab onto a sloped surface when the slide tab is inclined in the same direction as an inclination of the sloped surface;

FIG. 22 is an enlarge side view of a projection of a first shape and the slide tab;

FIG. 23 is an enlarge side view of the projection of a second shape and the slide tab;

FIG. 24 is an enlarge side view of the projection of a third shape and the slide tab; and

FIG. 25 is an illustration illustrating a movement of the slide tab when a slide part does not contact the sloped surface.

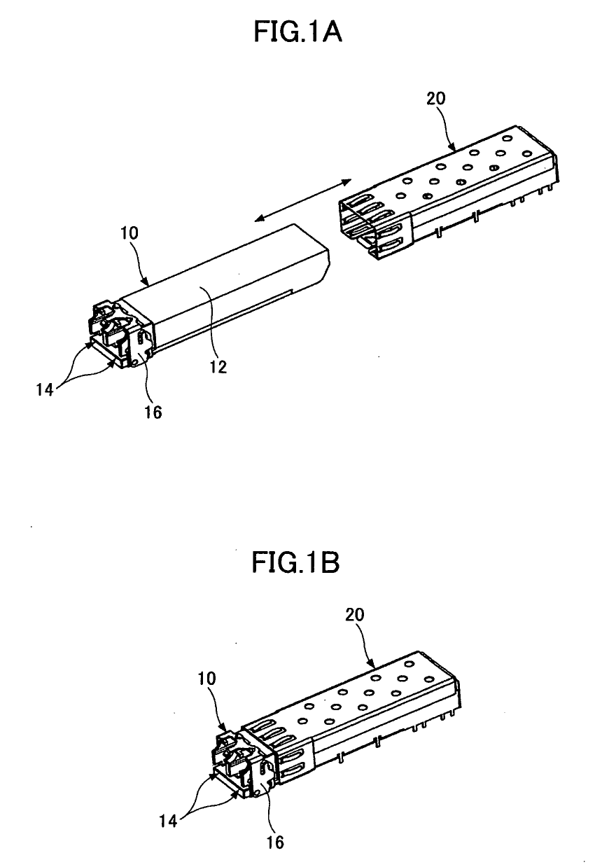

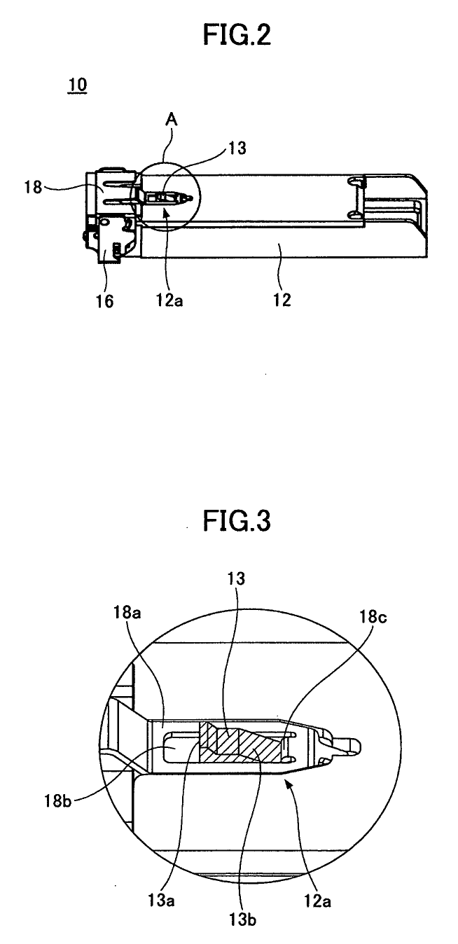

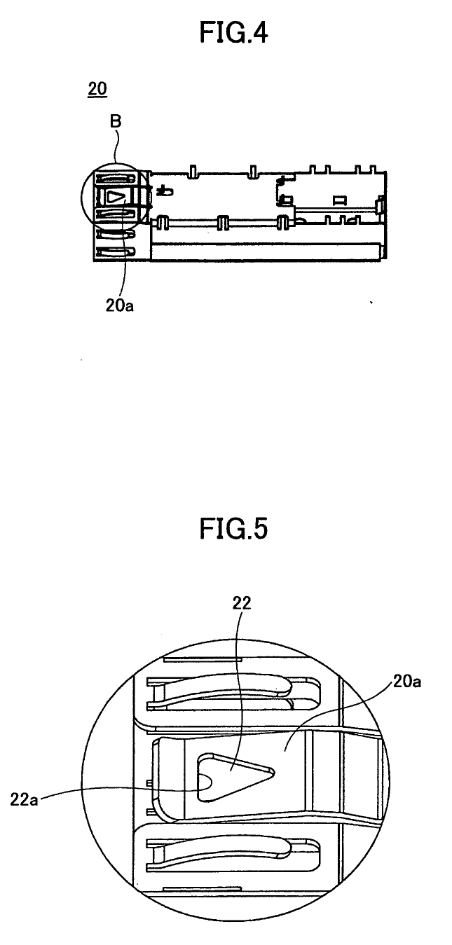

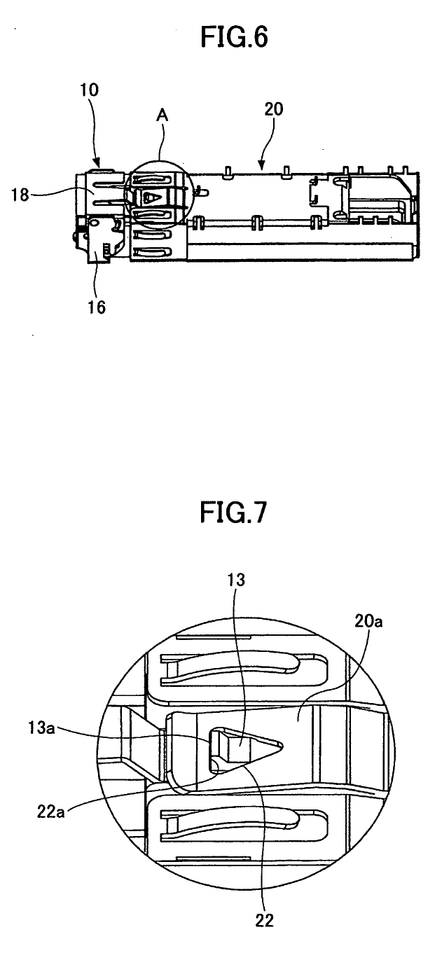

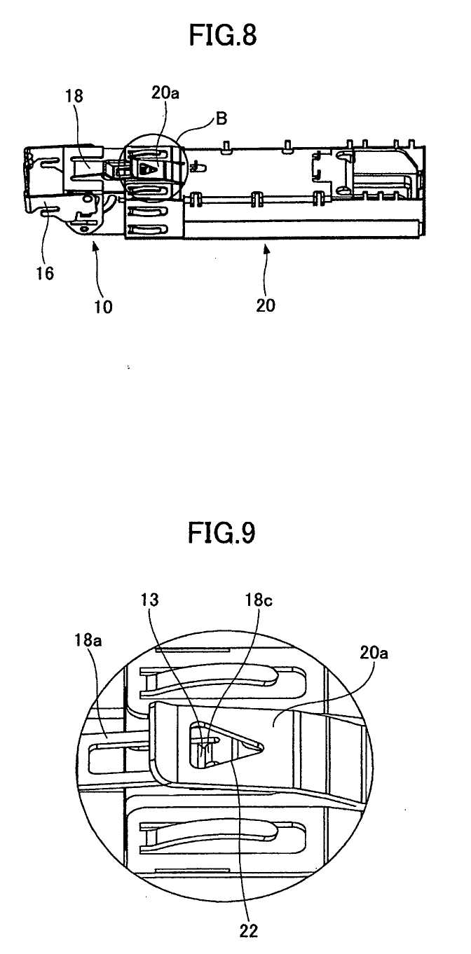

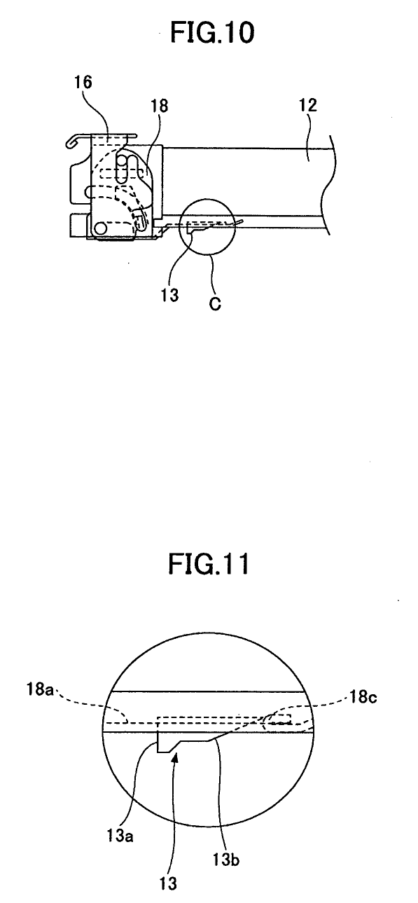

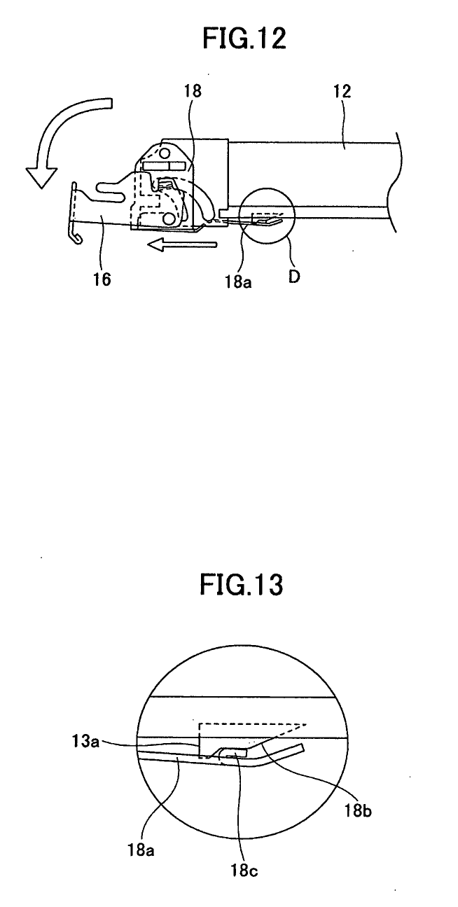

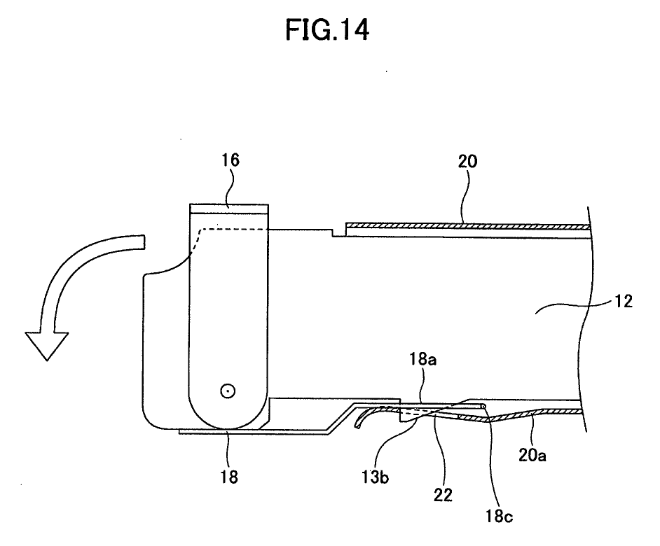

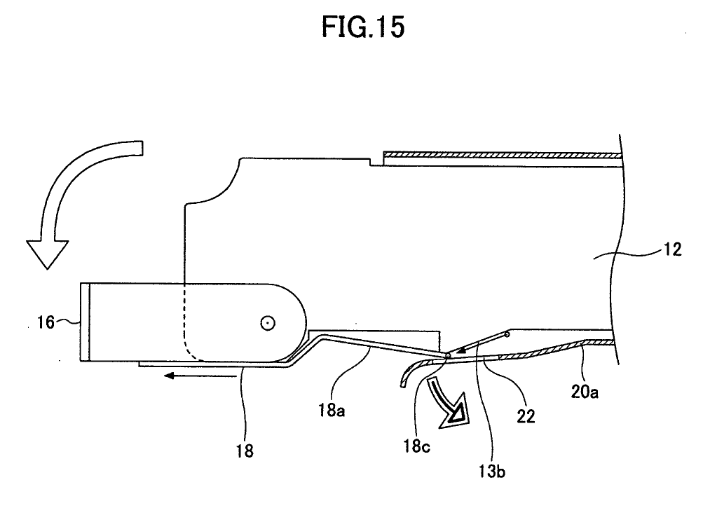

### DESCRIPTION OF EMBODIMENT(S)

Preferred embodiment of the present invention will be explained with reference to the accompanying drawings.

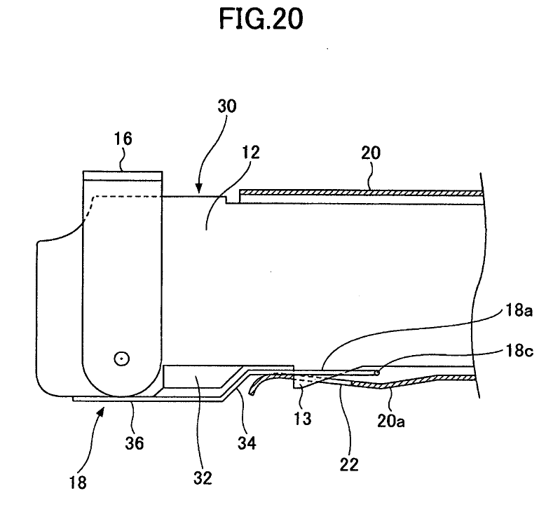

FIG. 20 is a schematic side view of a part of an optical module according to an embodiment. FIG. 20 illustrates a portion of the slide tab 18a and the projection 13 in a state where the bail 16 is at the upright position, that is, a locked state. The optical module 30 according to the present embodiment can be the same structure as the above-mentioned optical module 10 except for parts mentioned below. Thus, parts that are the same as the parts of the optical module 10 are given the same reference numerals, and descriptions of the parts explained in the description of the optical module 10 will be omitted.

As illustrated in FIG. 20, the optical module 30 according to the present embodiment is provided with a protruding part 32 between the slide member 18 and the case 12.

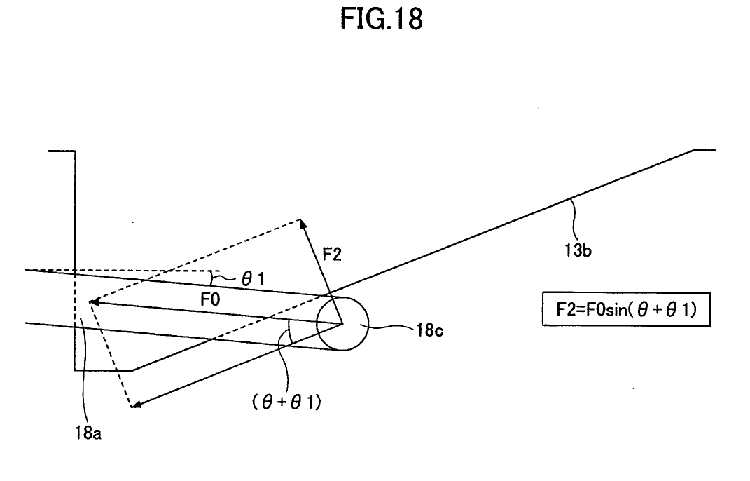

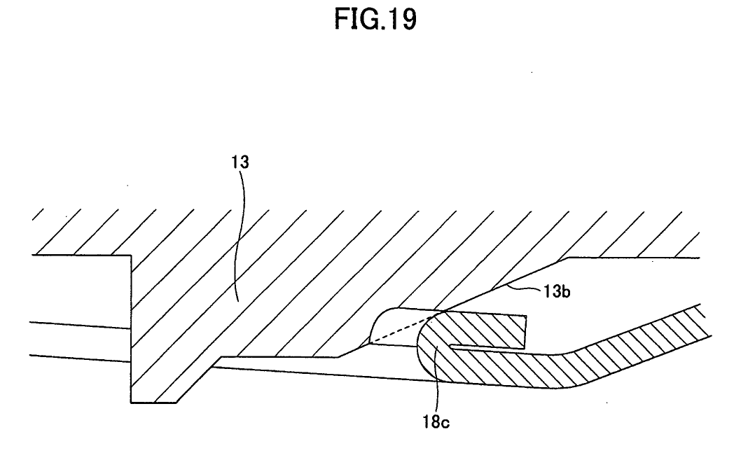

When the bail 16 is brought down in the locked state illustrated in FIG. 20, the slide tab 18a moves in the leftward direction in FIG. 18 by being interlocked with the rotation of the bail 16. Because the protruding part 32 is provided in the direction of movement of the slide tab 18a, the slide tab 18a is brought into contact with the protruding part 32 immediately after the slide tab 18a starts to move.

In the present embodiment, the slide member 18 includes a base part 36, an inclined part 34 and the slide tab 18. The base part 36 is movably supported on an end side of the case 12. The inclined part 34 extends obliquely from the base part 36. The slide tab 18a extends from the inclined part 34 in a longitudinal direction of the case 12. That is, the inclined part 34 is provided in a portion where the slide tab 18a is connected to the slide member 18 so that the inclined part 34 of the slide member 18 first contacts the protruding part 32. The base part 36 of the slide member 18 is coupled to the bail 16 so that the slide member 18 moves in the longitudinal direction of the case 12 in association with a rotation of the bail 16. Accordingly, the inclined part 34 and the slide tab 18a move in the longitudinal direction of the case 12 in association with the movement of the base part 36. As illustrated in FIG. 20, the protruding part 32 is a part protruding from the surface of the case 12 on the side of the base part 36 of the slide member 18 with respect to the projection 13.

In the present embodiment, the inclination angle θ of the slide tab 18a, when the slide part 18c contacts the sloped surface 13b of the projection 13, is adjusted by bringing a portion of the inclined part 34 or the slide tab 18a of the slide member 18 into contact with a sloped surface or a top surface of the protruding part 32. The slide tab 18a is caused to incline so that the inclination angle of the slide tab 18a decreases by an angle θ2 unlike the conventional technique in which the inclination angle of the slide tab 18a increases by the angle θ1. That is, the slide tab 18a is caused to incline by the angle θ2 in the same direction as the inclination angle of the sloped-surface 13b.

A pressing force F3 by which the slide part 18c is pressed onto the sloped surface 13b is represented by the pulling force F0, which pulls the slide tab 18a, multiplied by sin(θ−θ2) (F1=F0×sin(θ−θ2)). Therefore, when the slide part 18c slides on the sloped surface 13b, the pressing force by which the slide part 18c is pressed onto the sloped surface 13b is smaller than that of the conventional technique (F3<F1<F2). Thereby, the formation of a recess on the sloped surface 13b due to the slide part 18c being pressed onto the sloped surface 13b is suppressed, which permits the optical module being attached to and detached from the cage 20 for many times.

As mentioned above, the protruding part 32 is provided to decrease the inclination angle of the slide tab 18a, when the slide part 18c slides on the sloped surface 13b, to be smaller than that of the conventional technique. However, the inclination angle of the slide tab 18a changes depending on the shape of the protruding part 32.

A description will be given below of the shape of the protruding part 32 and the inclination angle of the slide tab 18a.

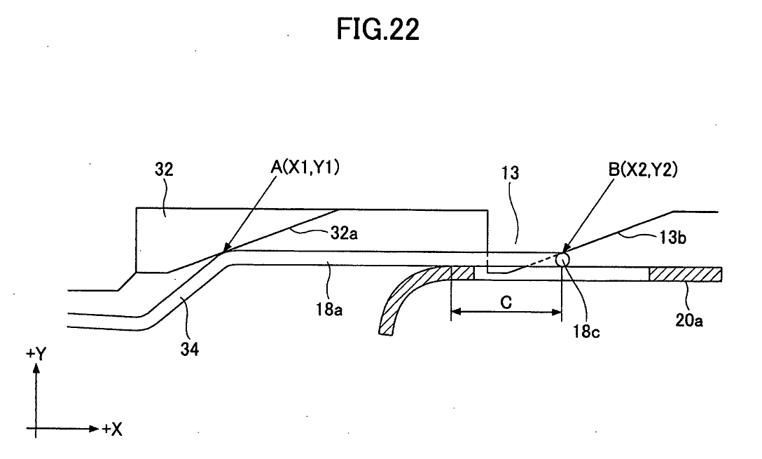

A first shape of the protruding part 32 illustrated in FIG. 22 is a shape which causes a bent portion between the slide tab 18a and the inclined part 34 to contact a sloped surface 32a of the protruding part 32 when the slide part 18c of the slide part 18a contacts and slides on the sloped surface 13b of the projection 13. That is, a position (point A) at which the bent portion between the slide tab 18a and the inclined part 34 is in contact with the sloped-surface 32a of the protruding part 32 is at the same level (the same position in the Y-direction) as a position (point B) at which the slide part 18c of the slide tab 18a is in contact with the sloped surface 13b of the projection 13. In FIG. 22, the X-direction is a direction in which the slide tab 18a extends when no force is applied to the slide tab 18a, and the Y-direction is a direction perpendicular to the surface of the slide tab 18a and also perpendicular to the X-direction.

If the protruding part 32 has the shape illustrated in FIG. 22, when the slide member 18 is pulled to move, the slide tab is in parallel with the same angle as the angle at the start of movement because a Y-direction position Y1 of the point A and a Y-direction position Y2 of the point B are at the same Y-direction position (Y1=Y2). That is, the slide part 18c slides on the sloped surface 13b while the inclination angle θ is maintained unchanged. If the protruding part 32 is not provided, the inclination angle θ increases gradually. On the other hand, in the example illustrated in FIG. 22, the inclination angle θ does not change even when the slide part 18c slides on the sloped surface 13b. Thus, the pressing force by which the slide part 18c presses the sloped-surface 13b does not increase, thereby a recess being hardly formed on the sloped surface 13b.

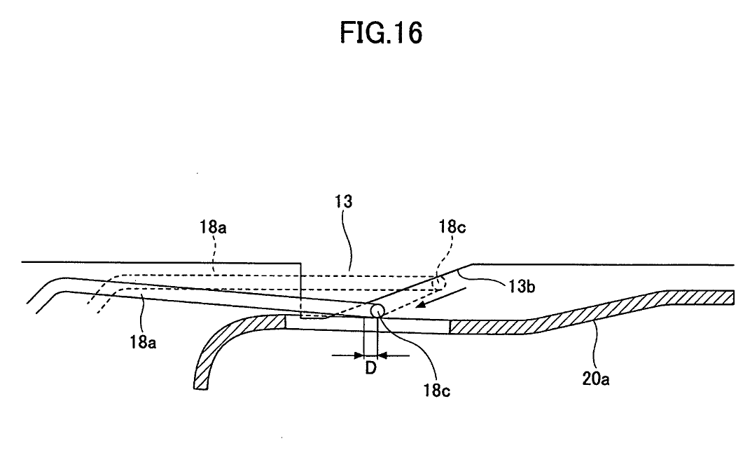

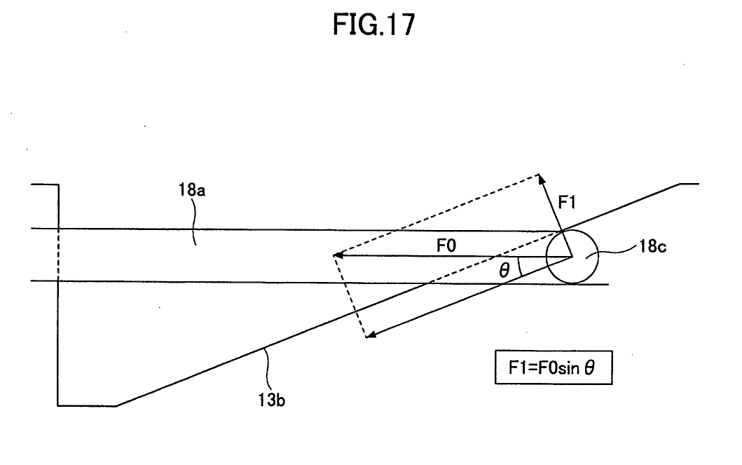

Moreover, in the example illustrated in FIG. 22, the slide tab 18a and the tongue-like tab 20a are maintained in parallel to each other when the tongue-like tab 20a is lifted by the slide part 18c sliding on the sloped surface 13b. Thereby, the tongue-like tab 20a is lifted by a portion of the surface of the slide tab 18a (a range indicated by C in FIG. 22) as illustrated in FIG. 22. On the other hand, in the conventional technique, the tongue-like tab 20a is lifted by only a portion close to the slide part 18c as illustrated in FIG. 16 (a range indicated by D in FIG. 16). That is, the tongue-like tab 20a is lifted by a narrow portion like a line in the conventional technique, while the tongue-like tab 20a is lifted by a large plane in the example illustrated in FIG. 22. Thereby, a force applied by the tongue-like tab 20a onto the slide tab 18a is dispersed in the example illustrated in FIG. 22, and the operation force to be applied to the bail 16 to unlock can be reduced.

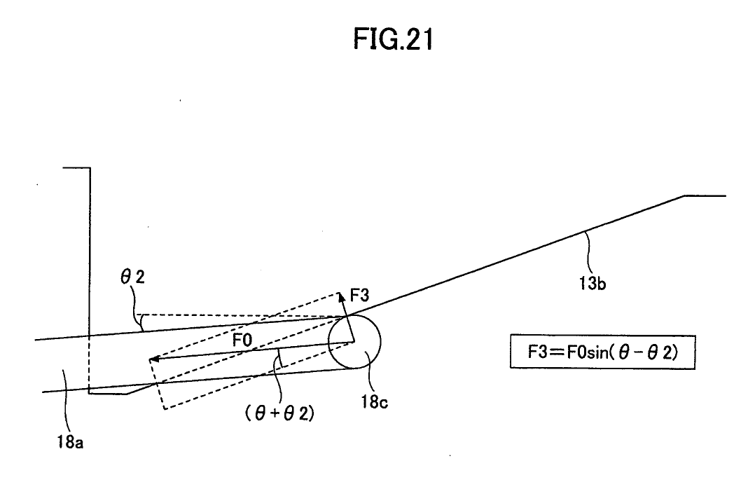

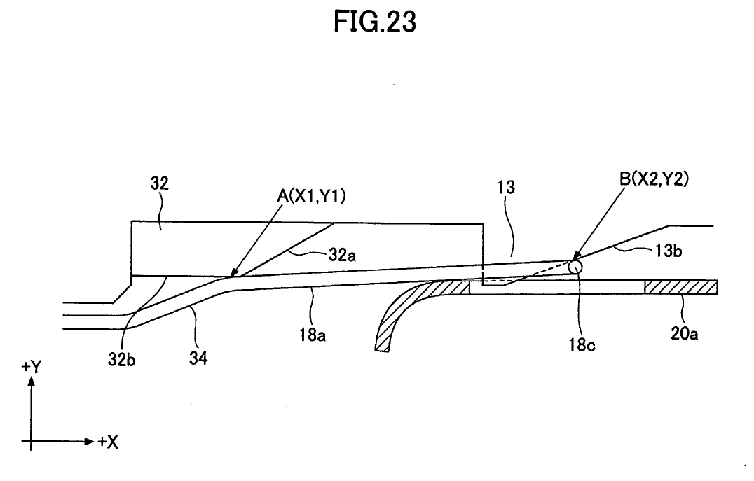

A second shape of the protruding part 32 illustrated in FIG. 23 is a shape which causes a bent portion between the slide tab 18a and the inclined part 34 to run on the top surface 32b of the protruding part 32 when the slide part 18c of the slide part 18a contacts and slides on the sloped surface 13b of the projection 13. That is, the bent portion between the slide tab 18a and the inclined part 34 runs on the top surface 42b of the protruding part 32 after contacting and sliding on the sloped surface 32a of the protruding part 32. A position (point A) at which the bent portion between the slide tab 18a and the inclined part 34 is in contact with the sloped-surface 32a of the protruding part 32 is at a level higher than a position (point B) at which the slide part 18c of the slide tab 18a is in contact with the sloped surface 13b of the projection 13. That is, a Y-direction position Y1 of the point A is lower than a Y-direction position Y2 of the point B (Y1<Y2). Accordingly, the inclination angle θ of the slide part 18c is smaller than the conventional angle θ as illustrated in FIG. 21. Thus, the pressing force by which the slide part 18c presses the sloped-surface 13b does not increase, and, thereby, a recess is hardly formed on the sloped surface 13b.

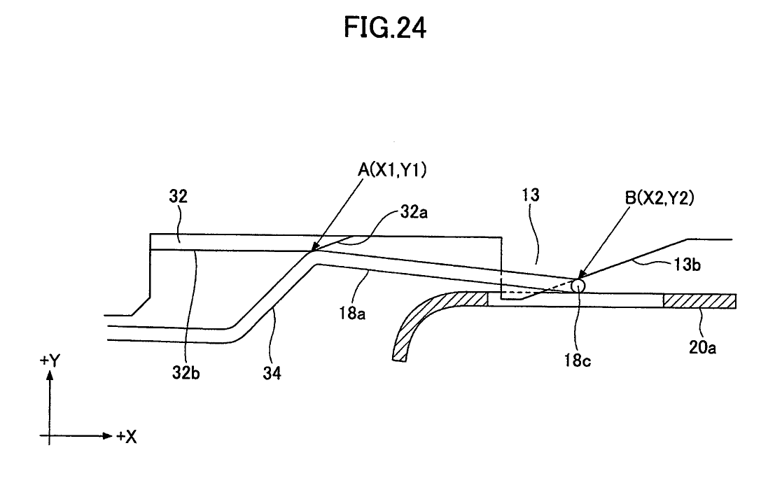

In a third shape of the protruding part 32 illustrated in FIG. 24, the top surface 32b is lower than the top surface 32b in the second shape illustrated in FIG. 23. Accordingly, the bent portion between the slide tab 18a and the inclined part 34 runs on the top surface 32b of the protruding part 32 immediately after the slide tab 18a moves by being pulled in the X-direction. A position (point A) at which the bent portion between the slide tab 18a and the inclined part 34 is in contact with the sloped-surface 32a of the protruding part 32 is at a level lower than a position (point B) at which the slide part 18c of the slide tab 18a is in contact with the sloped surface 13b of the projection 13. That is, a Y-direction position Y1 of the point A is higher than a Y-direction position Y2 of the point B (Y1>Y2). However, the inclination angle of the slide tab 18a is smaller than the angle θ1 illustrated in FIG. 18 when the protruding part 32 is not provided as illustrated in FIG. 18 because the position of the point A is raised to the level of the top surface 32b of the protruding part 32. Thus, the pressing force by which the slide part 18c presses the sloped-surface 13b is smaller than that of the conventional technique, and, thereby, a recess is hardly formed on the sloped surface 13b.

Although the inclination angle of the slide tab 18a changes depending on the shape of the protruding part 32, the inclination angle of the slide tab 18 is smaller than the inclination angle in the conventional technique and a recess is hardly formed on the sloped surface 13b because there is provided the protruding part 32 in each case. Thereby, the slide member 18 is prevented from being set in a state where the slide member 18 cannot move, and the optical module 30 can be attached to and detached from the cage 20 for many times.

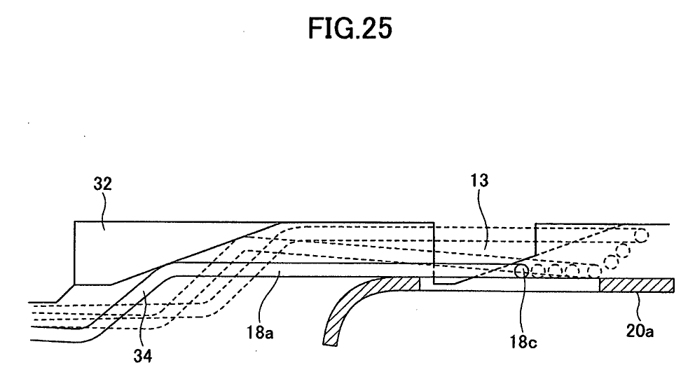

It should be noted that the slide part 18c can be moved to a position at which the slide part 18c contacts the tongue-like tab 20a while preventing the slide part 18c from being brought into contact with the sloped surface 13b. If the slide part 18c does not contact the sloped surface 13b of the projection 13 in the state where the bent portion between the slide tab 18a and the inclined part 34 is in contact with the sloped surface 32a of the protruding part 32, the slide tab 18a inclines so that the slide member 18 (the base part 36 illustrated in FIG. 20) is deformed to lift the slide part 18c. That is, if the slide member 18 is pulled in the state where the bent portion between the slide tab 18a and the inclined part 34 is in contact with the sloped surface 32a of the protruding part 32, the slide tab 18a inclines with the contact point as a supporting point. Thereby, the slide part 18c is lifted and moved to contact the tongue-like part 20a without contacting the sloped surface 13b. It should be noted that if the slide part 18c does not slide on the sloped surface 13b as illustrated in FIG. 25, there is no need to provide the sloped surface 13b in a portion where the slide part 18 does not slide, and, thus, the shape of the projection 13 may be changed as illustrated in FIG. 25.

All examples and conditional language recited herein are intended for pedagogical purposes to aid the reader in understanding the principles of the invention and the concepts contributed by the inventor to furthering the art, and are to be construed a being without limitation to such specifically recited examples and conditions, nor does the organization of such examples in the specification relates to a showing of the superiority and inferiority of the invention. Although the embodiment(s) of the present invention (s) has (have) been described in detail, it should be understood that the various changes, substitutions, and alterations could be made hereto without departing from the spirit and scope of the invention.

What is claimed is:

1. An optical module configured to be accommodated in a cage, comprising:
a case accommodating optical parts;
a projection provided on a surface of said case and having a vertical surface perpendicular to a longitudinal direction of said case;
a slide member including a base part, an inclined part and a slide tab, the base part being attached on one end of said case and movable in the longitudinal direction of said case, the inclined part extending in an oblique direction from said base part, the slide tab extending in the longitudinal direction beyond said projection and being movable in the longitudinal direction within a predetermined moving range; and
a protruding part provided on a side of said base part of said slide member with respect to said projection and protruding from said surface of said case.

2. The optical module according to claim 1, wherein said protruding part includes a sloped surface with which said slide tab contacts and slides.

3. The optical module according to claim 1, wherein said slide tab includes an aperture into which said projection enters, and said projection includes a sloped surface with which an edge part of said aperture extending in a direction perpendicular to the longitudinal direction contacts and slides when said slide tab moves in said predetermined moving range.

4. The optical module according to claim 2 wherein said protruding part includes a top surface connecting to said sloped surface at a predetermined protruding height.

5. The optical module according to claim 1, wherein said projection is provided on a bottom surface of a concave part provided on a bottom surface of said case.

6. The optical module according to claim 1, wherein said base part of said slide member is coupled to a lever member rotatably supported at said one end of said case so that said slide member is movable in the longitudinal direction in association with a rotation of said lever member.

7. The optical module according to claim 1, wherein said case is made of metal, and said protruding part and said projection are integrally formed with said case.
